(19) United States
(12) Patent Application Publication
(10) Pub. No.: US 2018/0233909 A1
(43) Pub. Date: Aug. 16, 2018

(54) SMART LOW VOLTAGE DIRECT CURRENT INFRASTRUCTURE

(71) Applicant: Howard L. REED, Baltimore, MD (US)

(72) Inventor: Howard L. REED, Baltimore, MD (US)

(21) Appl. No.: 15/954,965

(22) Filed: Apr. 17, 2018

Related U.S. Application Data
(63) Continuation-in-part of application No. 15/869,588, filed on Jan. 12, 2018.
(60) Provisional application No. 62/613,142, filed on Jan. 3, 2018.
(60) Provisional application No. 62/445,404, filed on Jan. 12, 2017.

(51) Int. Cl. H02J 3/00; H05B 33/08

(52) U.S. Cl. CPC H02J 3/00; H05B 33/0815; H05B 33/0842

(57) ABSTRACT

A method and system for the reduction of end-user electronic device power consumption. The system includes an electronic device comprising an electronic power board and a smart receptacle communicatively coupled with the electronic power board. The smart receptacle communicates with the electronic power board to determine an initial level of operational low voltage direct current (LVDC) voltage demand for the electronic device. The smart receptacle then delivers an initial level of operational LVDC voltage to the electronic device based on the communication. The electronic power board is also capable of generating a feedback power demand signal to the smart receptacle to modify the initial level of operational LVDC voltage.

### CROSS REFERENCE TO RELATED APPLICATIONS

This application is a continuation-in-part of U.S. patent application Ser. No. 15/869,588 filed Jan. 12, 2018 and claims the benefit of U.S. provisional Application No. 62/445,404, filed on Jan. 12, 2017, and of U.S. provisional Application No. 62/613,142, filed on Jan. 3, 2018, of which all of the contents are herein incorporated by reference in their entireties.

### FIELD OF THE INVENTION

This invention relates to the methods and systems for the control and distribution of low voltage direct current.

### BACKGROUND OF THE INVENTION

In the past few years, with the advent of electronic devices such as mobile devices, smart phones, multimedia equipment, home appliances and light emitting diode (LED) lighting, the use of direct current (DC) is ever increasing. Further, with the proliferation of solar panels and wind turbines, power generation has also embraced the usage of direct current. Advances in battery technology, including the popularity and feasibility of electric vehicles, is also based on direct current. However, stored and renewable energy is not infinite and requires increased efficiency in terms of generation, control and delivery.

### SUMMARY

Given the foregoing, what is needed is a method and system for efficiently delivering and controlling the demand of low voltage direct current to electronic devices. Further, there needs to be communications between the delivery system and the electronic device to determine and modify the level of operational low voltage direct current (LVDC) being delivered to the electronic device for increased efficiency.

In an embodiment of the present disclosure, a method for low voltage power distribution is presented. The method includes coupling an electronic device to a smart receptacle and then establishing communications between the electronic device and the smart receptacle. The communication determines an initial level of operational low voltage direct current (LVDC) voltage demand for the electronic device and delivers an initial level of operational LVDC voltage to the electronic device from the smart receptacle based on the communication, whether wired or wireless. Further, the method includes the generation of a feedback power demand signal from the electronic device to the smart receptacle that modifies the initial level of operational LVDC voltage based on the feedback power demand signal.

In an embodiment of the present disclosure, an on-demand system for low voltage power distribution includes an electronic device and a smart receptacle. The electronic device includes an electronic power board that is coupled with the smart receptacle. The smart receptacle communicates with the electronic power board to determine an initial level of operational low voltage direct current (LVDC) voltage demand for the electronic device. The smart receptacle is designed to deliver an initial level of operational LVDC voltage to the electronic device based on the communication between the smart receptacle and the electronic power board. Further, the electronic power board generates a feedback power demand signal to the smart receptacle to modify the initial level of operational LVDC voltage.

In an embodiment of the present disclosure, a method for LVDC distribution and control of a LED is presented. The method includes coupling a smart LED electronic module internal or external of the LED and then establishing communications between the smart LED electronics and the Power Feeder Module. The communication determines an initial level of operational LVDC voltage demand for the LED and delivers an initial level of operational LVDC voltage to the LED light from the power feeder module based on the communication. Further, the method includes the generation of a feedback power demand signal from the LED to the power feeder module that modifies the initial level of operational LVDC voltage based on the feedback power demand signal.

According to another embodiment, there is provided a non-transitory computer readable medium with instructions stored thereon to control low voltage direct current (LVDC) distribution, the controlling of the LVDC distribution includes coupling an electronic device to a smart receptacle, and establishing communications between the electronic device and the smart receptacle, wherein the communication determines an initial level of operational LVDC voltage demand for the electronic device. The controlling further includes delivering an initial level of operational LVDC voltage to the electronic device from the smart receptacle based on the communication, generating a feedback power demand signal from the electronic device to the smart receptacle, and modifying the initial level of operational LVDC voltage based on the feedback power demand signal.

In yet another embodiment, an on-demand system for a low voltage lighting system is provided comprising: a smart LED module and a power board comprising a LED light source; a power feeder module configured to supply a low voltage direct current (LVDC) to the smart LED module; and a switch configured to control power flow from the power feeder module to the smart LED module, wherein when the switch is engaged to allow power flow from the power feeder module to the smart LED module, a voltage level of the LVDC supplied by the power feeder module is based on a feedback signal from the smart LED module, wherein communication between the smart LED module and the power board determines an initial level of operational LVDC voltage demand for the LED light source, wherein the smart LED module delivers an initial level of operational LVDC voltage to the LED light source based on the communication, and wherein the power board is further configured to generate a feedback power demand signal to the smart LED module to modify the initial level of operational LVDC voltage.

Further features and advantages of the present disclosure, as well as the structure and operation of various embodiments of the present disclosure, are described in detail below with reference to the accompanying drawings. It is noted that the present invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the present invention and to enable a person skilled in the relevant art(s) to make and use the present invention.

Additionally, the left-most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which are the same in structure, operation, or form but may be identified as being in different locations in space or recurring at different points in time (e.g., reference numbers ‘110a’ and ‘110b’ may indicate two different energy detection devices which are functionally the same, but are located at different points in a simulation arena).

FIG. 1 illustrates a set of power sources and building infrastructures using alternating current (AC) and direct current (DC), according to an embodiment of the present disclosure.

FIG. 2 depicts a smart grid system that includes a power feeder module, smart receptacle and electronic power board, according to an embodiment of the present disclosure.

FIG. 3 depicts a power feeder module within a smart grid system, according to an embodiment of the present disclosure.

FIG. 4A depicts a smart receptacle within a smart grid system using two-prong and three-prong plug types, according to an embodiment of the present disclosure.

FIG. 4B depicts a legacy AC adapter plug type for a smart receptacle, according to an embodiment of the present disclosure.

FIG. 4C depicts an illustration of a smart extension with a receptacle outlet, according to an embodiment of the present disclosure.

FIG. 4D depicts a block diagram of a smart extension adaptor with a receptacle outlet, according to an embodiment of the present disclosure.

FIG. 5 depicts a three-prong end-user electronic power board within a smart grid system, according to an embodiment of the present disclosure.

FIG. 6 depicts a two-prong end-user electronic power board within a smart grid system, according to an embodiment of the present disclosure.

FIG. 7 depicts bias clocking, according to an embodiment of the present disclosure.

FIG. 8 depicts an end-user electronic board with a three-prong with a three-prong plug in a circuit power “off” state, according to an embodiment of the present disclosure.

FIG. 9 depicts an end-user electronic board with a three-prong with a three-prong plug in a circuit power “on” state, according to an embodiment of the present disclosure.

FIG. 10 depicts an end-user electronic board with a two-prong with a two-prong plug in a circuit power “off” state, according to an embodiment of the present disclosure.

FIG. 11 depicts an end-user electronic board with a two-prong with a two-prong plug in a circuit power “on” state, according to an embodiment of the present disclosure.

FIG. 12 depicts an AC adapter plug for legacy applications, according to an embodiment of the present disclosure.

FIG. 13 depicts a smart LED light and smart module, according to an embodiment of the present disclosure.

FIG. 14 depicts a smart LED light with a built in smart module, according to an embodiment of the present disclosure.

FIG. 15 illustrates a flow chart of a method for low voltage power distribution, according to an embodiment of the present disclosure.

FIG. 16 depicts a battery with a battery operated smart electronic device, according to an embodiment of the present disclosure.

FIG. 17 depicts a smart battery with a battery operated smart electronic device, according to an embodiment of the present disclosure.

FIG. 18 illustrates an example computer implementation, according to an embodiment of the present disclosure.

Further embodiments, features, and advantages of the present invention, as well as the operation of the various embodiments of the present invention, are described below with reference to the accompanying FIGS.

### DETAILED DESCRIPTION OF THE INVENTION

While embodiments described herein are illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The embodiments described herein are referred in the specification as “one embodiment,” “an embodiment,” “an example embodiment,” etc. These references indicate that the embodiment(s) described can include a particular feature, structure, or characteristic, but every embodiment does not necessarily include every described feature, structure, or characteristic. Further, when a particular feature, structure, or characteristic is described in connection with an embodiment, it is understood that it is within the knowledge of one skilled in the art to affect such feature, structure, or characteristic in connection with other embodiments whether or not explicitly described.

Smart LVDC infrastructure, which can also be referred to as a smart efficient power distribution, or an end-user smart grid, can provide on-demand LVDC for end-user electronic appliances and light emitting diode (LED) lights. Such a smart LVDC infrastructure can be used to construct a smart grid system for use with electronic devices. This application's reference to any “end-user electronic device” or “electronic device” includes “end-user appliances” and “LED lights.”

Smart LVDC infrastructure reduces end-user electronic device power consumption by providing only the required voltage demand for end-user electronic device operation. Smart LVDC infrastructure will alleviate unnecessary Alternate Current (AC) legacy power conversion process and can reduce power consumption in power board components in electronic devices up to 90%. Further, end-user energy consumption and its associated pollution can be reduced by over 50%. For the purposes of this application, “low voltage” is meant to be consistent with the European Union directive 2014/35/EC that defines the voltage levels delivered to a device as being less than 1500 volts for DC and less than 1000 volts for AC.

Smart LVDC infrastructure is based on a concept of duty cycle modulation, which will be described in more detail further in the application. Duty cycle modulation can also be referred to as “DC throttling,” “frequency bias gating,” or “duty cycle” and uses transistors, or their equivalent. The embodiments described herein are not meant to be limited to any particular type of circuit switching component including but not limited to the use of MOSFET, switching transistors, basic transistors, simulation software, or the like.

Smart LVDC infrastructure uses an on-demand approach, throttling the LVDC input power source based on the LVDC demand of the electronic device. The throttling, or duty cycle modulation, originates in the end-user electronic device and is communicated to a receptacle and power modules. As will be further discussed, LVDC power delivery to the electronic device is maintained slightly above the electronic device's operation voltage demand, where a threshold percentage is not limited to typically stated range of 20% to 30%.

Such an approach reduces the electronic device's power consumption as compared to the legacy AC power conversion process, which further negates the need for AC/DC converters, power inverters, transformers, buck circuits, booster circuits, voltage divider circuits and bridge diode circuit configurations. Smart LVDC infrastructure can be used to construct an end-user smart power grid layout that may be used for wide area high voltage direct current (HVDC) power distribution, solar power array systems, battery storage systems, vehicles, planes, ships, satellites, space vessels, submarines, street lights, and habitat living facilities, e.g., residential, commercial, industries, factories, bunkers, emergency facilities, apartments, hotels, motels and hospitals.

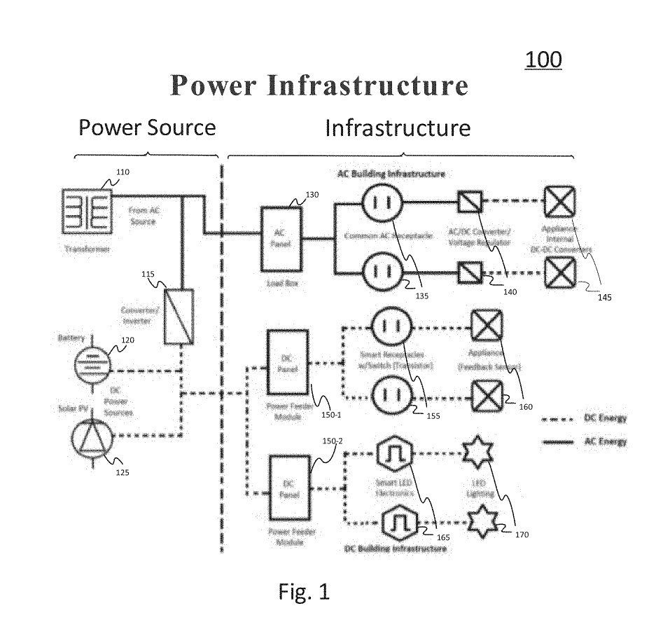

FIG. 1 illustrates a hybrid power source/infrastructure system 100, according to an embodiment. System 100 includes an AC transformer 110, an AC panel 130, multiple AC receptacles 135, multiple AC/DC converters 140 and multiple internal DC-DC converters 145. System 100 also includes a power source converter/inverter 115 and DC power sources such as a battery 120 and solar photovoltaic system 125. System 100 further includes DC panels 150-1 and 150-2, multiple smart receptacles 155, and appliances 160 with internal feedback sensors and smart LED electronics 165 with internal feedback sensors and LED lighting 170.

System 100 illustrates a legacy AC power source such as AC transformer 110 that delivers AC energy, as shown by the grey solid line, to a typical AC panel, typically located in a building or home, which distributes the AC energy through the structure to multiple AC receptacles 135. If the appliance or electronic device has components driven by direct current, then an AC/DC converter 140 is used to convert the AC to DC. Further, many appliances and electronic devices may require multiple DC voltages that require a further conversion using an internal DC-DC converter 145.

In an embodiment, a home, commercial building or any other type of structure or complex could consist of only DC based power sources and infrastructure or a hybrid combination of both AC and DC sources and infrastructures as illustrated in system 100.

System 100 also illustrates a DC based power source, such as battery 120 or solar photovoltaic system 125 that generates and delivers direct current to DC panels 150-1 and 150-2. DC panel 150-1 is then connected to multiple smart receptacles 155 and then to appliances 160, with DC panel 150-2 connected to smart LED electronics 165 to LED lighting 170. The flow of DC energy is illustrated by the dashed line from the DC power source to DC panels 150. In the delivery of DC energy to DC panels 150 there is no need to converter AC to DC through the use of inverters. System 100 also illustrates the use of power source converter/inverter 115 to convert AC to DC for delivery to DC panels 150 in addition to, or to supplement, the DC energy delivered to DC panel 150s by battery 120 and solar photovoltaic system 125.

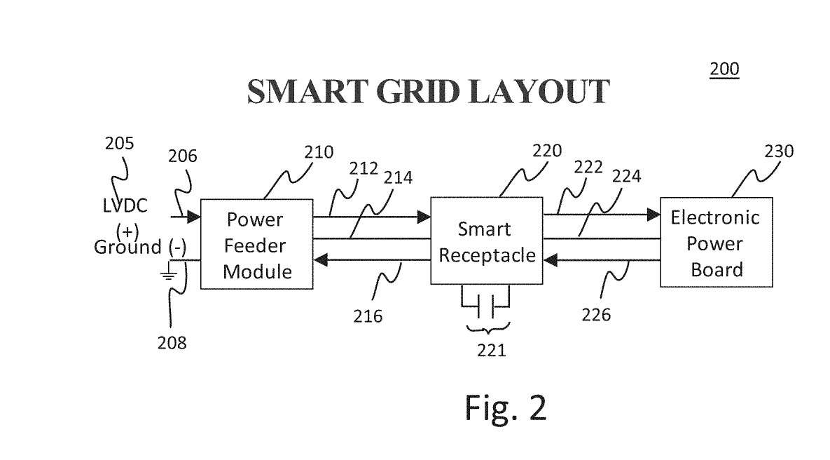

FIG. 2 illustrates a portion of the components of a smart grid system 200, according to an embodiment. Smart grid system 200 includes a LVDC source power 205, a power feeder module :210, a smart receptacle 220 and an electronic power board 230 within an electronic device (not shown).

Power feeder module 210 contains circuitry that is connected to LVDC source power 205 through connection 206 and grounded through connection 208. Power feeder module 210 is also connected to smart receptacle 220 where line 212 carries an input voltage, line 214 represents a ground, and line 216 carries smart receptacle 220's bias voltage. Smart receptacle 220 also includes contacts 221. When an appliance, or any electronic device, is plugged into smart receptacle 220, contacts 221 are closed and will energize smart receptacle 220 as will be discussed in further detail.

Electronic power board 230 is contained within an electronic device. Electronic power board 230 is connected to smart receptacle 220 where line 222 delivers an output voltage from smart receptacle 220 to electronic power board 230. Line 226 carries a bias voltage from electronic power board 230 to smart receptacle 220 and line 224 is a ground. The bias voltages on lines 226 and 216 are used to communicate the power demand of an electronic device from electronic power board 230 and the power demand for smart receptacle 220 from power feeder module 210. In an embodiment, bias voltages on line 226 is used to increase power demand from smart receptacle 220 using line 216 to communicate an increasing of the voltage output reference from power feeder module 210 on line 212 until the output voltage level from smart receptacle 220 on line 222 threshold is greater. For example, when smart receptacle 220's input voltage of line 212 is at less than a threshold percentage of the smart receptacle output voltage on line 222, then the bias voltage on line 216 would be “on.” Conversely, when the smart receptacle input voltage of line 212 is at more than a threshold percentage of the smart receptacle output voltage on line 222, then the bias voltage on line 216 would be “off.”

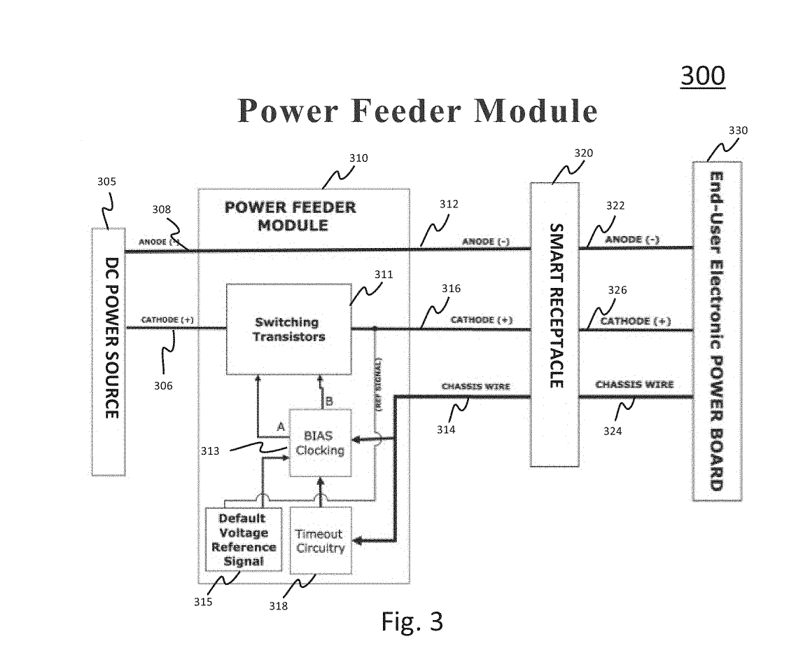

FIG. 3 depicts a more detailed view of a power feeder module in a smart grid system 300, according to an embodiment. Smart grid system 300 includes a DC power source 305, e.g., batteries or solar photovoltaic cells, a power feeder module 310, a smart receptacle 320 and an end-user electronic power board 330 coupled with an electronic device (not shown).

DC power source 305 can be any type of DC power source, including as previously discussed batteries, solar photovoltaic cells or legacy AC power inverter. DC power source 305 is coupled to power feeder module 310 through cathode (+) 306 and anode (−) 308. Smart receptacle 320 and end-user electronic power board 330 are interconnected in a similar manner, e.g., through cathode (+) 316 and 326, and anode (−) 312 and 322. In addition, chassis wire 324 is used to control bias feedback from end-user electronic power board 330 to smart receptacle 320 and chassis wire 314 is used to control bias feedback from smart receptacle 320 to power feeder module 310.

In essence, power feeder module 310 replaces the legacy AC circuit breakers. Typically, power feeder module 310 would be mounted near DC power source 305. A building would typically include multiple power feeder modules 310 where each power feeder module 310 would supply LVDC for rooms, lights, and feed-lines in support of any connected end-user electronic devices.

In an embodiment, power feeder module 310 has two modes of operation. The first mode is where power feeder module 310 outputs a preset level of LVDC voltage, e.g., a fixed voltage output power. The output voltage can be any preselected level. The second mode is where the voltage output power of cathode (+) 316 is variable, e.g., a variable level of LVDC voltage, and is based on a reference output set upon a feedback on-demand signal received from smart receptacle 320, which can be constantly changing.

In an embodiment, power feeder module 310 includes switching transistors 311, a bias clocking circuit 313, a default voltage reference signal circuit 315 and timeout circuitry 318. Switching transistors 311 are used to vary LVDC output based on output from bias clocking circuit 313. Within switching transistors 311, one or more switching transistors are configured in parallel with each other's input and output supplying a stable LVDC power to cathode (+) 316 and smart receptacle 320 and ultimately to end-user electronic power board 330 within an electronic device.

Bias clocking circuit 313 is used to control the output voltage on cathode (+) 316 by controlling switching transistors 311 through the use of duty cycle modulation or as previously referred to “DC throttling.” DC throttling of the output voltage is accomplished by varying the frequency of the bias clocking to gated switching transistors. Increasing the bias feedback through chassis wire 314 results in an increasing of the clocking frequency. The increased frequency results in a higher duty cycle on the switching transistors in switching transistors 311. A higher duty cycle means that the switching transistors remain closed for a longer time, thus resulting in raising the output voltage on cathode (+) 316.

Conversely, by removing the bias signal on chassis wire 314, clocking frequency referencing for bias clocking circuit 313 is set. A lower duty cycle means that the switching transistors remain closed for a shorter time, thus resulting in lowering the output voltage on cathode (+) 316.

In addition, timeout circuitry 318 can be configured to reduce the output frequency of bias clocking circuit 313 to lower the output voltage on cathode (+) 316 after a preset or threshold time period. For example, if the feedback bias signal on chassis wire 314 removes voltage demand or if there is nothing plugged into smart receptacle 320, then timeout circuitry 318 can drive bias clocking circuit 313 to produce a minimal output voltage on cathode (+) 316 after a preset time.

Timeout circuitry 318 can also be configured to engage after a predetermined time, which can be referenced as a “recycling period.” When the bias signal is removed the reference trigger for a recycling period is initiated. Triggering of the recycling-period will initiate a reduction in cathode (+) 316 output voltage. Once the predetermined count down time is met a reset signal is sent to bias clocking circuit 313 to decrease the output voltage on cathode (+) 316 to a predetermined default voltage setting as determined by default voltage reference signal circuit 315. If the end-user electronic device operation power demand is still required, the feedback sensing circuitry in end-user electronic power hoard 330 will reinitiate its voltage demand signal. The demand signal will occur before operation voltage is affected and, in an embodiment, is communicated via chassis wire 314 and 324 using a wired or wireless communication. Further, power feeder module 310 recycle-period timing can be set to any particular time, e.g., 2 minutes. Further, smart receptacle 320 also contains a timeout circuit that is controlled by its own recycling-period time. Typically, the timeout period for smart receptacle 320 may be set to a longer time frame than for power feeder module 310.

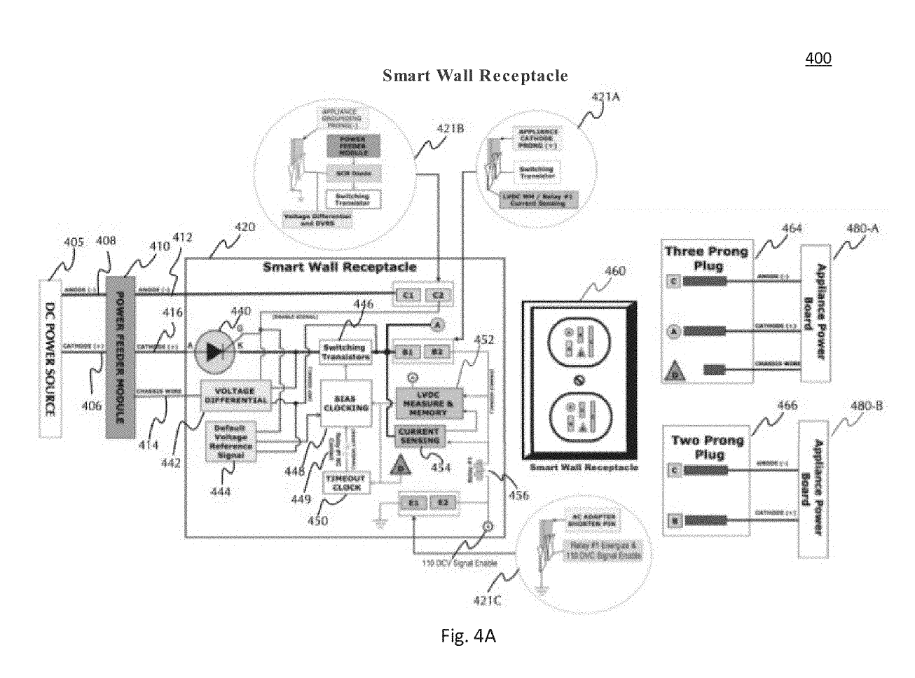

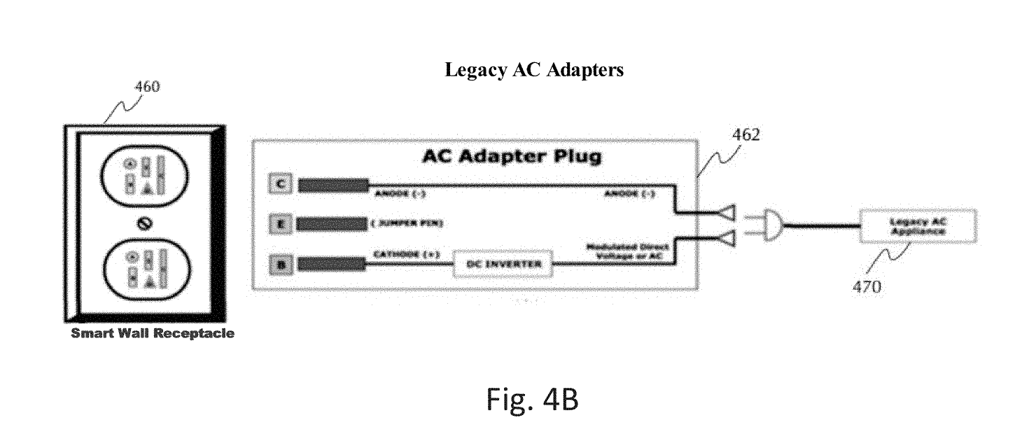

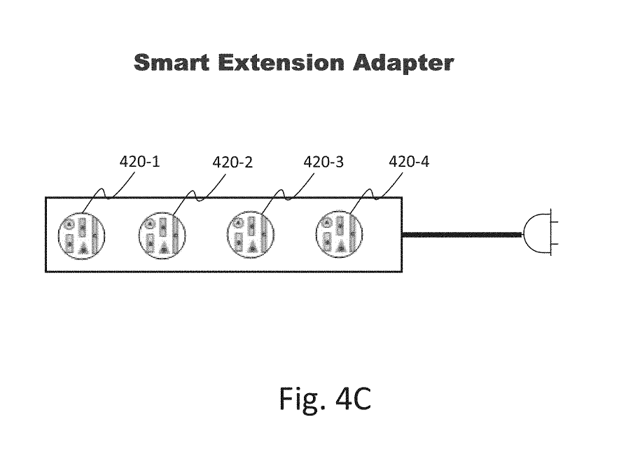

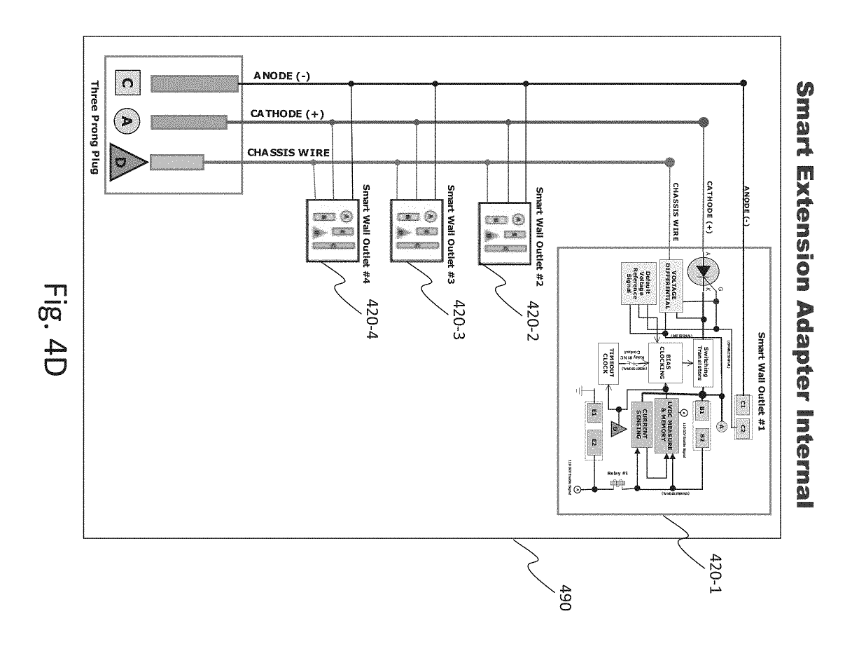

FIG. 4A depicts a more detailed view of a smart receptacle in a smart grid system 400, according to an embodiment. Smart grid system 400 includes a DC power source 405, a power feeder module 410, a smart receptacle 42.0 and an illustration of a possible receptacle outlet 460.

Similar to smart grid system 300, smart grid system 400 contains a DC power source 405 that is coupled to power feeder module 410 through cathode (+) 406 and anode (−) 408. Smart receptacle 420 is coupled to power feeder module 410 through cathode (+) 416 and anode (−) 412. In addition, chassis wire 414 is used to control bias feedback to power feeder module 410.

In an embodiment, smart receptacle 420 includes a silicon-controlled rectifier (SCR) 440, a voltage differential circuit 442, a default voltage reference signal circuit 444, switching transistors 446, a bias clocking circuit 448, a relay #1 NC contact 449, a timeout clock circuit 450, LVDC measure and memory circuit 452, a current sensing circuit 454 and a relay #1 456, SCR 440 and switching transistors 446 are used to vary LVDC output based on output from bias clocking circuit 448. Within switching transistors 446, one or more switching transistors are configured in parallel with each other's input and when enabled supply a stable LVDC power to appliance cathode prong pin (A) or in pin “B1/B2” As shown in 421A.

SCR 440 and switching transistors 446 control LVDC output from smart receptacle 420. Further, smart receptacle 420 receives feedback from a three-prong plug-in 480-A or two-prong plugin 480-B, as will be described later and initiates a LVDC increase demand signal would initiate power demand to its power feeder module 410 to maintain a threshold voltage above the attached end-user electronic device operation power demand, typically by 20%-30%. Bias clocking circuit 448 controls DC throttling by increasing or decreasing the bias signal frequency to the gated switching transistors 446 base. SCR 440 allows INDC output for its prospective smart receptacle 420 port.

Timeout clock circuit 450 will remove unnecessary voltage demand whenever the end-user electronic device is in sleep-mode or off-mode after a predetermined amount of time. During the Two-Prong end-user electronic device plug-in operation the LVDC measurement and memory circuit 452 will memorize voltage level during the voltage polling process, as will be described later. During the Two-Prong end-user electronic device power demand the current sensing circuit 454 will initiate voltage increase demand via LVDC measurement and memory circuit 452 for the end-user electronic device operation if it senses an increased current demand due to turning on the electronic device from an off-mode or sleep-mode. In an embodiment, the LVDC measurement and memory circuit 452 can also perform just a measurement function, e.g., a measurement circuit and while monitoring voltage output during two-prong operation.

Smart receptacle 420 includes multiple single and split pin pairs. For example, in an embodiment, smart receptacle 420 includes split pin pairs B1/B2, C1/C2 and E1/E2. The pins are “shorted” or “bridged” and connected when a prong of a plug is inserted into smart receptacle 420. When no plug is inserted into smart receptacle 420 the split pin pairs are open and therefore fail to conduct between the pin pairs. For example, when no plug is inserted into smart receptacle 420, split pin pair B1/B2 is open and no power flows from switching transistors 446 to LVDC measure and memory circuit 452, relay #1 456 and current sensing circuit 454. However, when, as shown in circle 421A, an appliance cathode prong is inserted into smart receptacle 420 bridging pins B1 and B2 activating LVDC measure and memory circuit 452 and current sensing circuit 454, thus allowing power to relay #1 456. The split pin pairs can also be referred to as bridge pins.

In a similar manner, split pin pair C1/C2, shown in circle 421B, is used to activate SCR 440 allowing LVDC input power to the switching transistors 446, enabling default voltage reference signal circuit 444 and voltage differential circuit 442. And, bridging pin pair E1/E2, shown in circle 4210, would provide grounding to Relay #1 456 (relay would energize if power is present from pin pair B1/B2). Energizing relay #1 456 would open relay #1 Normal Close (NC) contact 449, preventing timeout clock circuit 450 signal from reaching the bias clocking circuit 448 and applying a negative signal input to LVDC measure and memory circuit 452 at label “A” that will set an output voltage for B1/B2.

Smart receptacle 420 also includes single pins A and D. Pin A receives LVDC from switching transistors 446. Pin D is used to allow feedback communications from a three-prong electronic device to smart receptacle 420.

During two-prong electronic device connection, smart receptacle 420 also includes a LVDC measure and memory circuit 452 and current sensing circuit 454. LVDC measure and memory circuit 452 measures and regulates the switching transistors 446 output on Pin “B” shown as “B1” and “B2.” LVDC measure and memory circuit 452 signals switching transistors 446 via bias clocking circuit 448 to increase voltage output to the end-user operation voltage obtained during the voltage polling process. During the voltage polling process LVDC measure and memory circuit 452 will measure and record output voltage for the two-prong end-user electronic device via pin “B2.” The pin pairs of B1 and B2 can also be referred to as bridge pins

In an embodiment, smart receptacle 420 is configured as shown in illustration 440 as a wall receptacle accepting five prongs, labeled A, B, C, D and E.

FIG. 4A also depicts receptacle outlet 460 with multiple possible plugs, according to an embodiment. A three-prong plug 464 and two-prong plug 466 are also shown that connect to appliance power boards 480-A and 480-B coupled with electronic devices. These examples are non-limiting, but are shown to illustrate sonic possible adapter and plug configurations.

Pin “A”—Pin A is used in the coupling of receptacle outlet 460 to three-prong plug 464 and represents cathode (+) that receives LVDC from switching transistors 446.

Pin “B”—Pin B is used in two-prong plug 466 and represents cathode (+) that bridges pins B1 and B2, thus activating LVDC measure and memory circuit 452and current sensing circuit 454 to provide power to relay #1 456 and AC adapter plug 462 cathode (+) input. Pin “B” is used in AC adapter plug 462 and two-prong plug 466 to attach to receptacle outlet 460.

Pin “C”—Pin C represents anode (−) and is used in bridging pins C1 and C2, thus activating SCR 440 allowing LVDC input power to switching transistors 446, default voltage reference signal circuit 444 and voltage differential circuit 442. Pin “C” used in AC adapter plug 462, three-prong plug 464 and two-prong plug 466, attaching to receptacle outlet 460.

Pin “D”—Pin D is used in three-prong plug 464 in coupling with receptacle outlet 460 in which an end-user electronic device 480-A via chassis pin “D” plug allows feed-back signal communication to smart receptacle 420.

Pin “E”—Pin E is used in AC adapter plug 462 to bridge pins E1 and E2, thus proving ground to energize Relay #1 456 and open Normal Close (NC) contact 449 to prevent timeout clock circuit 450 to send a signal to the bias clocking circuit 448 while applying a negative input signal to LVDC measure and memory circuit 452 at label A. Pin pairs “E1/E2” can also be referred to as bridge pins.

The above references to “pins” are meant to be figurative in the sense that “pins” can refer to any type of connection. For example a coupling between a three-prong plug 464 and smart receptacle 420 can be accomplished mechanically or through or in conjunction with any other type of power transfer coupling technology such as wireless, inductive, radio frequency, magnetic resonance or other similar technologies.

FIG. 4B depicts an AC adapter plug 462 that allows for the connection of a legacy AC appliance 470 to connect into receptacle outlet 460, according to an embodiment

FIG. 4C is an illustration of a smart extension adaptor that includes multiple receptacle outlets, according to an embodiment. For example, smart extension adapter 490 is shown with 4 smart receptacles, 420-1, 420-2, 420-3 and 420-4. Smart extension adapter 490 could be configured with any number of smart receptacles and is not meant to be limiting, but rather illustrates another embodiment of how smart receptacles can be configured.

FIG. 4D depicts a block diagram of a smart extension adaptor with multiple receptacle outlets, according to an embodiment. FIG. D includes smart extension adapter 490 with four smart receptacles 420-1, 420-2, 420-3 and 420-4. As with FIG. 4C, smart extension adapter 490 could be configured with any number of smart receptacles. FIG. 4D shows a possible electrical connection scenario utilizing multiple smart receptacles.

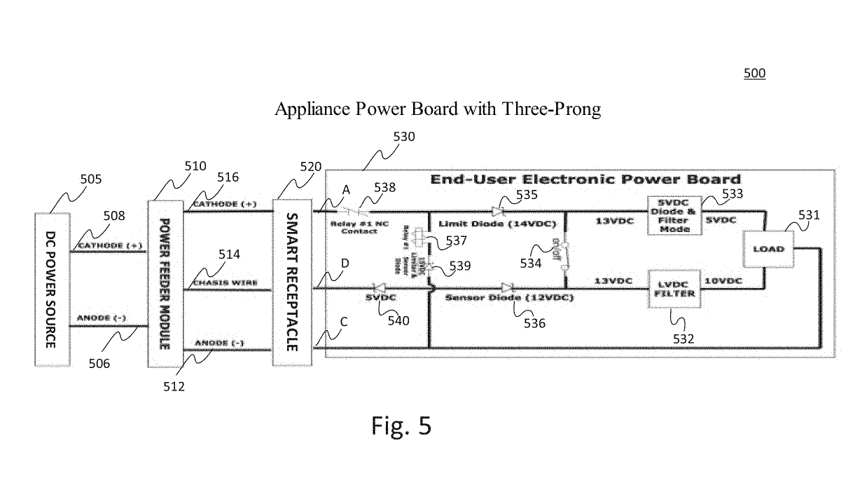

FIG. 5 depicts a three-prong end-user electronic power board within a smart grid system 500, according to an embodiment. Smart grid system 500 includes a DC power source 505, a power feeder module 510, a smart receptacle 520 and an end-user electronic power board 530 coupled with an electronic device (not shown). DC power source 505 is coupled to power feeder module 510 through cathode (+) 508 and anode (−) 506. Power feeder module 510 is coupled to smart receptacle 520 through cathode (+) 516, anode (−) 512 and chassis wire 514.

FIG. 5, and as was shown in FIG. 4A, shows a three-prong plug that connects into the C, A and D receptacle prongs. End-user electronic power board 530 controls the voltage on-demand input for appliance power operations and protects against over-voltage from smart receptacle 520.

In an embodiment, end-user electronic power board 530 includes a load 531, a relay #1 NC contact 538, a limit diode 535, an on/off switch 534, an operational voltage filter circuit 532, a 5 VDC diode and filter circuit 533, a feedback sensor diode 536, a limit relay #1 537, a limiter and sensor diode 539 and a diode 540. During standby or off mode, relay #1 NC contact 538 and limit diode 535 provide LVDC power during an “off” or “sleep” mode to allow for the controlling of load 531.

Over voltage protection utilizes relay #1 NC contact 538, limit relay #1 537, limiter and sensor diode 539 and limit diode 535 during over voltage occurrence, limit relay#1 537 will energize, in an example, the limiter and sensor diode 539 would allow set voltage to bias and energize limit relay #1 537, opening relay#1 NC contact 538 to protect load 531 and end-user power board circuits from over voltage.

A feedback voltage source is initiated from smart receptacle 520 from input “A” to end-user electronic power board 530 via relay #1 NC contact 538, limit diode 535, on/off switch 534, feedback sensor diode 536 and diode 540 back to pin “C”, thus increasing DC input voltage to end-user electronic power board 530 until operational voltage is reached and the feedback sensor diode 536 block further feedback voltage.

Feedback sensor diode 536 is used to feedback a bias signal to increase the clocking output to the bias clocking circuit 448, thus increasing DC output from switch transistor 446 on smart receptacle 520's cathode (+) labeled “A” until the feedback sensor diode 536 preset feedback voltage is achieved for the proper end-user electronic device operation voltage. Relay #1 537 is used as a limiting relay and is energized if the output voltage on prong “A” reaches approximately 45%-50% over the end-user electronic device operation voltage as an overvoltage protection. The relay #1 NC contact 538 provides connectivity from smart receptacle prong “A” into end-user electronic power board 530's components and opens when the relay #1 537 is energized during an over-voltage occurrence.

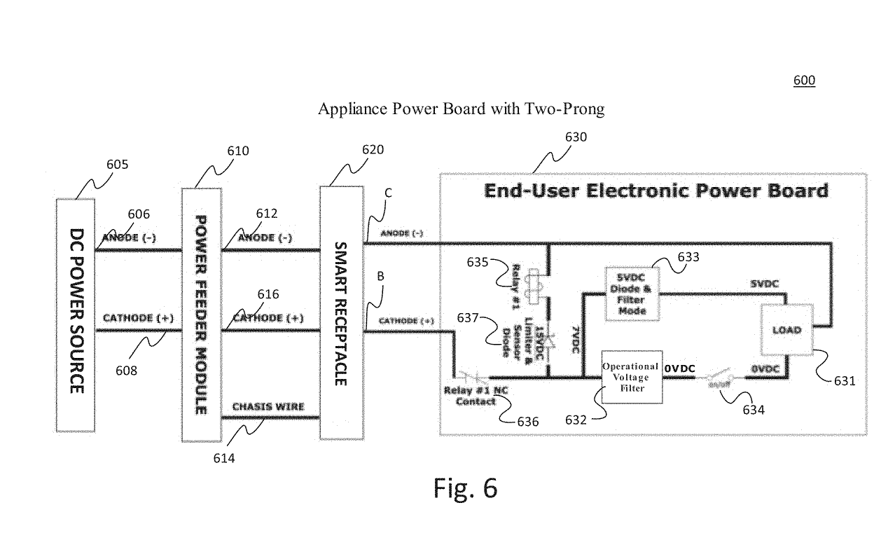

FIG. 6 depicts an end-user electronic power board 630 within a smart grid system 600, according to an embodiment. Smart grid system 600 includes a DC power source 605, a power feeder module 610, a smart receptacle 620 and an end-user electronic power board 630 coupled with an electronic device (not shown). DC power source 605 is coupled to power feeder module 610 through cathode (+) 608 and anode (−) 606. Power feeder module 610 is coupled to smart receptacle 620 through cathode (+) 616, anode (−) 612 and chassis wire 614.

As shown in FIG. 4A, a two-prong plug 466 connects into the “B” and “C” plugs, which is also shown in FIG. 6. End-user electronic power board 630 helps determine the end-user electronic board 630 power requirement during the initial plug-in, also known as a voltage polling process, and protects against over-voltage from smart receptacle 620.

End-user electronic power hoard 630 includes a relay #1 NC contact 636, a 5 vdc diode filter circuit 633, an operation voltage filter circuit 632, an on/off switch 634, a limit relay #1 635, a limiter and sensor diode 637 and device load 631.

The voltage polling process or over voltage mode utilizes relay #1 NC contact 636, limit relay #1 635 and limiter and sensor diode 637. The standby or off mode utilizes relay #1 NC contact 636, 5 vdc diode filter circuit 633 and device load 631.

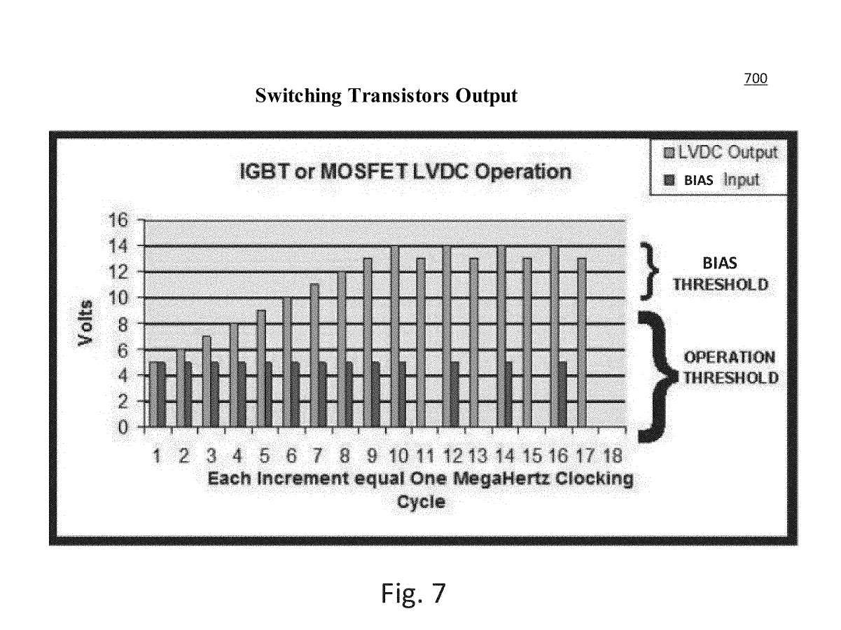

FIG. 7 displays the usage of a bias clocking signal and DC output voltage from switching transistors, according to an embodiment. The chart in FIG. 7 displays a one megahertz clocking signal, but any frequency could be used. In FIG. 4A, bias clocking circuit 448 produces the bias signal sent to switching transistors 446. Increasing bias input frequency, e.g., from bias clocking circuit 448 to switching transistors 446 increase LVDC output at pins “B1/B2” and pin “A.”

Initial plug-in for the two-prong electronic device will initiate the “voltage polling cycle,” thus increasing the bias signal clocking until the LVDC output voltage exceeds its connected electronic device threshold value, e.g., 20%-30% above the end-user electronic device operational voltage. Once the target voltage is reached the bias signal is removed by energized relay#1 635 and open relay #1 NC contact 636, FIG. 4A LVDC measure and memory circuit 452 records “B1/B2” voltage output level and drive bias signal to the bias clocking circuit 448 until recorded voltage is reached at pin “B1/B2” from switching transistors 446 duty cycle transition illustrated in FIG. 7. FIG. 4A current sensing circuit 454 would detect increase of current usage demand from FIG. 6 end-user electronic power board 630 if on/off switch 634 is ON. If FIG. 4A current sensing circuit 454 senses a decrease of current, on/off switch 634 is OFF for a period of time and a reset signal will be sent to LVDC measure and memory circuit 452 to decrease clocking/voltage to a default voltage output. Once the current sensing circuit 454 senses an increase of current the reset signal sent to LVDC measure and memory circuit 452 to increase voltage to the memorized voltage level recorded during the voltage polling process. Unplugging the two-prong electronic device would reinitiate the voltage polling process.

Three-prong bias operation is initiated FIG. 5 smart receptacle 520 plug connector “A”, relay #1 NC contact 538, limit diode 535, on/off switch 534, feedback sensor diode 536 5 VDC diode 540 and back to smart receptacle 520 via plug connector “D”. FIG. 4A plug “D” sends a bias signal to timeout clock circuit 450 to initiate the clock once the bias signal is removed and bias clocking circuit 448 to increase clocking output to switching transistor 446 thereby increasing LVDC output to plug “A,” which will raise the voltage to end-user electronic power board 530. Once electronic voltage is achieved, feedback sensor diode 536 will block feedback bias voltage to smart receptacle 520. Bias clocking circuit 448 will maintain clocking reference and timeout clock circuit 450 will initiate its preset timeout countdown for power recovery if the end-user device is off or in standby mode. If power operation demand is still required for end-user electronic power board 530, then the system will reinitiate the process before operation voltage is affected.

Further, timeout clock circuit 450 will cycle through its predetermine timeout cycle and attempt to decrease bias signal by sending a “reset signal” to the bias clocking circuit 448 via relay#1 NC contact 449 for both three-prong and two-prong operation. If the electronic on-demand voltage is still required or a bias threshold has been reduced close to the operation threshold setting, the bias signal would reinitiate via chassis wire or wireless communication from the end-user electronic power board 530 equipment or smart receptacle 520. In addition, bias clocking circuit 448 would be reset.

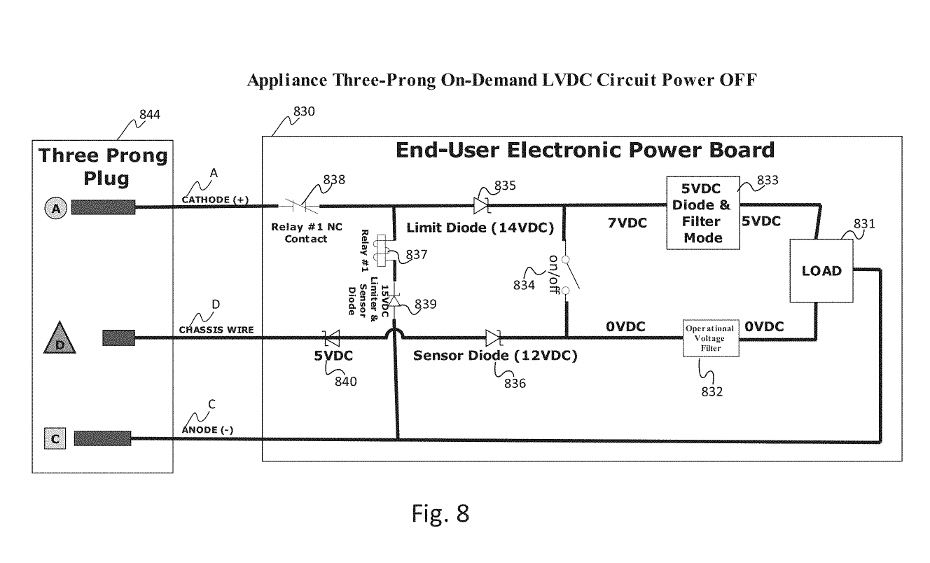

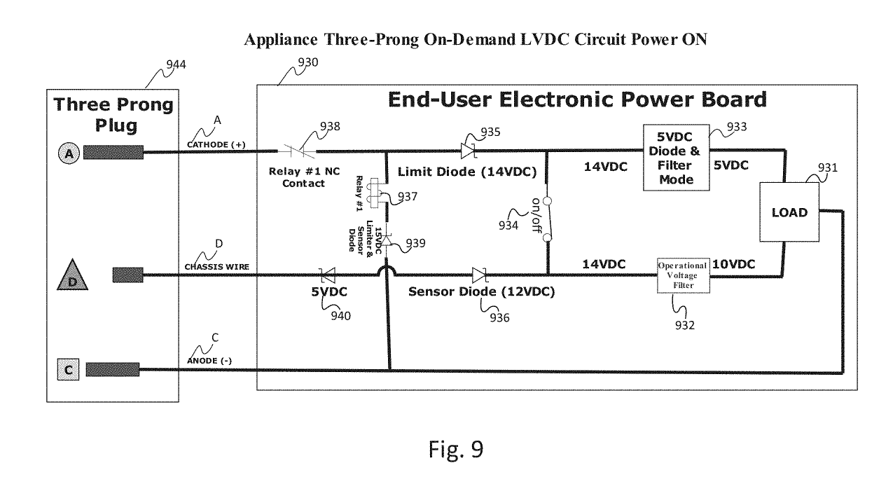

FIG. 8 depicts an end-user electronic power board 830 with a three-prong plug 844 in a circuit power “off” state, according to an embodiment. In a similar manner, FIG. 9 depicts an end-user electronic power board 930 with a three-prong plug 944 in a circuit power “on” state, according to an embodiment.

FIGS. 8 and 9 both depict the use of three-prong plugs, 844 and 944. The circuits shown in FIGS. 8 and 9 use an on-demand LVDC power requirement of 14 VDC that includes a 4 VDC bias threshold and a 10 VDC operational power with a default voltage of approximately 5 VDC. These values are only examples and are not meant to be limiting. As previously discussed, “low voltage” is directed to a DC voltage of less than 1500 volts.

When a three-pronged electronic device is plugged into a smart receptacle, pins A, C and D are engaged. If, as in FIG. 8, end-user electronic power board 830 is in an “off” state then power is received from cathode (+) at pin A, a ground connection is made with anode (−) at pin C, and feedback communication is enabled via chassis pin D. A three-prong anode bridges pins C1 and C2 as shown in FIG, 4A in smart receptacle 420 and applies a negative signal to SCR 440, allowing LVDC to flow to switching transistors 446, further enabling default voltage reference signal circuit 444 and voltage differential circuit 442. The pin pairs of C1 and C2 can also be referred to as bridge pins

In an embodiment, end-user electronic power board 830 includes a load 831, a relay #1 NC contact 838, a limit diode 835, an on/off switch 834, an operational voltage filter circuit 832, a 5 VDC diode and filter circuit 833, a feedback sensor diode 836, a limit relay #1 837, a limiter and sensor diode 839 and a diode 840.

During standby or off mode, relay #1 NC contact 838, limit diode 835 and diode and filter circuit 833 provide LVDC power during an “off” or “sleep” mode to allow for the controlling of load 831.

Over voltage protection utilizes relay #1 NC contact 838, limit relay #1 837, limiter and feedback sensor diode 836 and limit diode 835. During over voltage occurrence, limit relay#1 837 will energize, in an example, the limiter and feedback sensor diode 836 and open relay#1 NC contact 838, while limit diode 835 protects load 831 from over voltage.

In an embodiment, end-user electronic power board 930 includes a load 931, a relay #1 NC contact 938, a limit diode 935, an on/off switch 934, an operational voltage filter circuit 932, a 5 VDC diode and filter circuit 933, a feedback sensor diode 936, a limit relay #1 937, a limiter and sensor diode 939 and a diode 940.

During standby or off mode, relay #1 NC contact 938, limit diode 935 and diode and filter circuit 933 provide LVDC power during an “off” or “sleep” more to allow for the controlling of load 931.

Over voltage protection utilizes relay #1 NC contact 938, limit relay #1 937, limiter and feedback sensor diode 939 and limit diode 935. During over voltage occurrence, the limiter and feedback sensor diode 936 will bias allowing limit relay #1 937 to energize and open relay #1 NC contact 938, while limit diode 935 protects load 931 from over voltage.

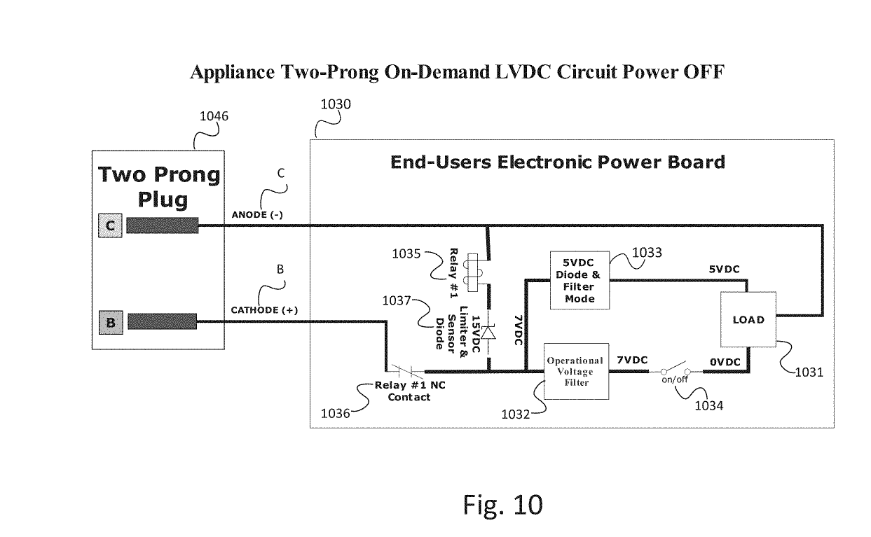

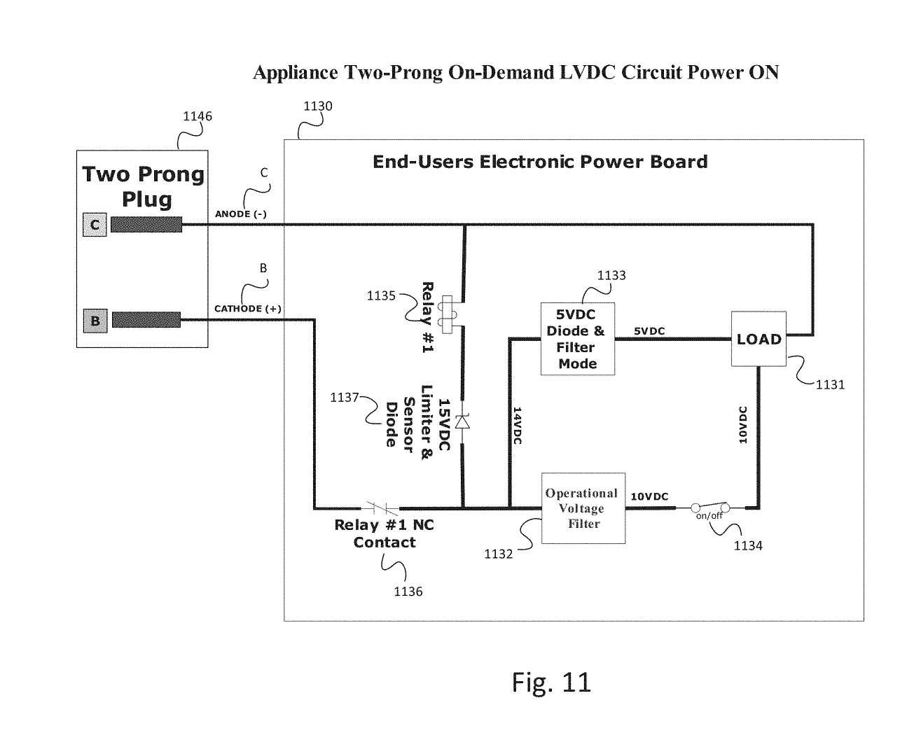

FIG. 10 depicts an end-user electronic power board 1030 with a two-prong plug 1046 in a circuit power “off” state, according to an embodiment. In a similar manner, FIG. 11 depicts an end-user electronic power board 1130 with a two-prong plug 1146 in a circuit power “on” state, according to an embodiment.

In an embodiment, end-user electronic power board 1030 includes a load 1031, an operational voltage filter circuit 1032, a 5 VDC diode and filter circuit 1033,an on/off switch 1034, a limit relay #1 1035, a relay #1 NC contact 1036 and a limiter and sensor diode 1037.

in an embodiment, end-userelectronic power board 1130 includes a load 1131, an operational voltage filter circuit 1132, a 5 VDC diode and filter circuit 1133,an on/off switch 1134, a limit relay #1 1135, a relay #1 NC contact 1136 and a limiter and sensor diode 1137.

FIGS. 10 and 11 both depict the use of two-prong plugs, 1046 and 1146. The circuits shown in FIGS. 8 and 9 use an on-demand LVDC power requirement of 14 VDC that includes a 4 VDC bias threshold and a 10 VDC operational power with a default voltage of approximately 5 VDC. These values are only examples and are not meant to be limiting.

When a two-pronged electronic device is plugged into a smart receptacle, pins B and C are engaged. The two-prong anode bridges pins C1 and C2 as shown in FIG. 4A, applying a negative signal to SCR 440 and allows LVDC to flow to switching transistors 446, enabling default voltage reference signal circuit 444 and voltage differential circuit 442. The two-prong cathode bridges pins B1 and B2 and enables LVDC measure and memory circuit 452 and current sensing circuit 454.

If, as in FIG. 10, end-user electronic power board 1030 is in an “off” state then current sensing circuit 454 in smart receptacle 420 senses the lack of current demand and removes the bias enable signal to LVDC measure and memory circuit 452. LVDC measure and memory circuit 452 will then no longer compare voltage readings or send a feedback signal to bias clocking circuit 448. Once LVDC measure and memory circuit 452 is disabled by the current sensing circuit 454, default voltage reference signal circuit 444 would provide reference to bias clocking circuit 448 for switching transistors 446 output voltage, the output voltage of switching transistors 446 will be maintained at the default voltage output level.

As the two-prong configurations shown in FIGS. 10 and 11 lack the “chassis” connection of a three-prong connection that was used to communicate a feedback signal, a method of voltage polling is used for feedback control between end-user electronic power board 1130 and smart receptacle 420. Once connected, LVDC measure and memory circuit 452 will start a voltage polling process by increasing the voltage until current sensing circuit 454 detects no current flow and removes reset signal from LVDC measure and memory circuit 452. Once operational voltage has been reached for end-user electronic power board relay 1130, relay #1 1135 will energize via limiter and sensor diode 1137 and open the relay #1 NC contact, thus stopping current flow from smart receptacle 420. Thereafter, LVDC measure and memory circuit 452 will record, monitor and control end-user electronic power board 1130 operational voltage.

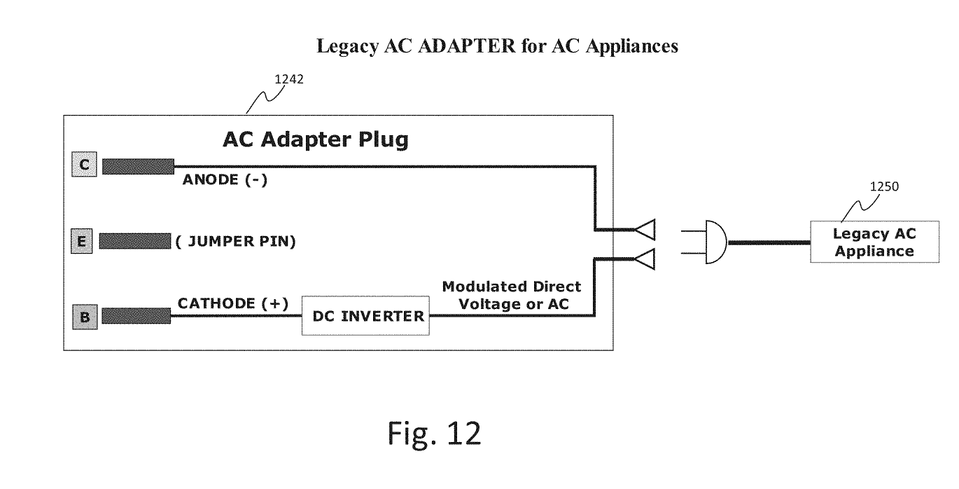

FIG. 12 illustrates the use of an AC adapter plug for use with legacy AC appliances, such as legacy AC appliance 1250, according to an embodiment. FIG. 12 is based on the example of using 110 VDC level for operational power. AC adapter plug 1242 plugs into smart receptacle 420 via pins B, C and E. AC adapter plug 1242 receives DC voltage from cathode (+) from pin B and the ground connection anode (−) from bridge pin C and jumper pin E. The cathode (+) of AC adapter plug 1242 bridges pins B1 and B2 in smart receptacle 420 thereby applying a positive signal to enable LVDC measure and memory circuit 452, relay #1 456 and current sensing circuit 454.

The anode of AC adapter plug 1242 bridges pins C1 and C2 applying a negative signal to SCR 440, thus allowing LVDC to flow to switching transistors 446 and enabling default voltage reference signal circuit 444 and voltage differential circuit 442. The jumper pin of AC adapter plug 1242 bridges pins E1 and E2 applying a negative signal to signal point A (110 vdc reference output signal) to LVDC measure and memory circuit 452, in FIG. 4A, on the LVDC measure and memory circuit 452 and ground to energize relay 456, opening relay #1 NC contact 449, thus preventing current timeout clock circuit 450 from sending a reset signal to bias clocking circuit 448 during use of the AC adapter plug 1242. AC adapter plug 1242 can also include any type of DC inverter to deliver modulated DC or pure sine wave AC, or any other waveform typical of a DC inverter.

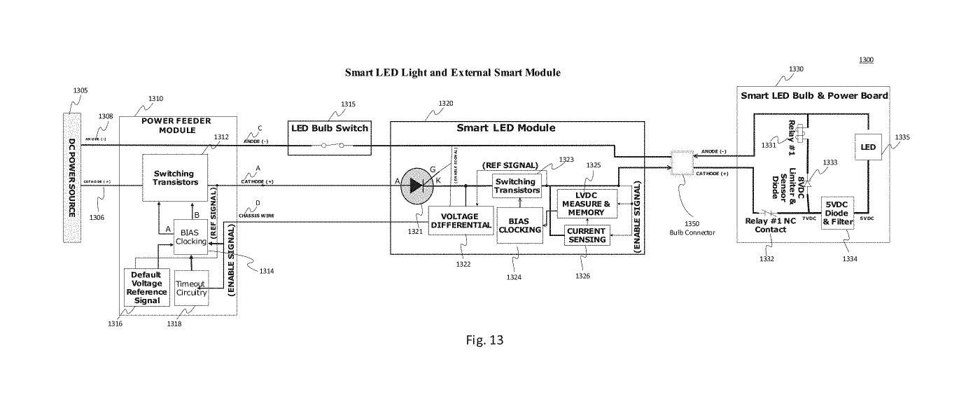

FIG. 13 illustrates a smart LED light system 1300, i.e., a low voltage lighting system, according to an embodiment. Smart LED light system 1300 includes a DC power source 1305, a power feeder module 1310, a smart LED module 1320, an LED bulb switch 1315, bulb connector 1350 and a smart LED bulb, i.e., a LED light source, and power board 1330.

Power feeder module 1310 is connected to DC power source 1305 through anode 1308 and cathode 1306. Power feeder module 1310 includes switching transistors 1312, bias clocking circuit 1314, default voltage reference signal circuit 1316 and timeout circuit 1318.

Smart LED module 1320 includes SCR 1321, voltage differential circuit 1322, switching transistors 1323, bias clocking circuit 1324, LVDC measure and memory circuit 1325 and current sensing circuit 1326.

Power feeder module 1310 operates in the same manner as power feeder module 310, 410, 510 and 610 previously discussed. Power feeder module 1310 maintains power level demands for attached smart LED module 1320. SCR 1321, voltage differential circuit 1322, switching transistors 1323, bias clocking circuit 1324, LVDC measure and memory circuit 1325 and current sensing circuit 1326 also function in the same manner as the corresponding circuits described in FIGS. 3-6 previously discussed.

Smart LED bulb and power board 1330 plugs into bulb connector 1350 via plug-in cathode (+) and anode (−).Smart LED bulb and power board 1330 includes relay #1 1331, relay #1 NC contact 1332, limiter and sensor diode 1333, 5 VDC diode and filter 1334 and LED 1335. When LED bulb switch 1315 is turned on, a negative signal to SCR 1321 allows LVDC to flow to switching transistors 1323 and enables voltage differential circuit 1322. Further, when LED bulb switch 1315 is turned on a positive signal from switching transistors 1323 enables LVDC measure and memory circuit 1325 and current sensing circuit 1326.

LVDC measure and memory circuit 1325 signals switching transistors 1323 via bias clocking circuit 1324 to increase voltage output until current sensing circuit 1326 no longer senses a current flow to smart LED bulb and power board 1330. Throughout this process, LVDC measure and memory circuit 1325 measures and records output voltage to the smart LED bulb and power board 1330 via cathode (+) output.

Smart LED light system 1300 uses the polling process as previously discussed. During the first initial turning on LED bulb switch 1315, relay #1 1331 inside smart LED bulb and power board 1330 energizes and opens relay #1 NC contact 1332, thus stopping current flow from smart LED module 1320. Thereafter, smart LED module 1320 delivers the recorded end-user electronic device operation voltage below its limitation until smart LED bulb and power board 1330 is unplugged, LED switch 1325 is turned off or an over operation voltage occurrence is detected.

Voltage differential circuit 1322 monitors the voltage level and if needed will feedback to power feeder module 1310 to maintain input threshold power above switching transistors 1323 output, e.g., at 20%-30%.

Once the LED bulb switch 1315 is turned off and current sensing circuit 1326 falls below a predetermined current level it will remove its enable signal from LVDC measure and memory circuit 1325. LVDC measure and memory circuit 1325 will no longer compare voltages or generate a feedback signal to bias clocking circuit 1324. Once switching transistors 1323 input voltage decreases, voltage differential circuit 1322 initiates a bias feedback signal to increase its connected power feeder module 1310 power output via chassis wire “C” or wireless communication.

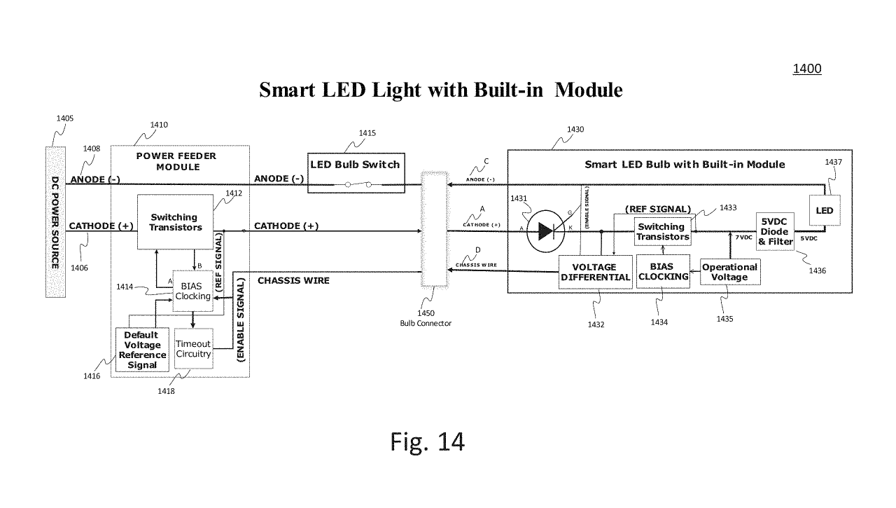

FIG. 14 illustrates a built-in smart LED light system 1400, according to an embodiment. Built-in smart LED light system 1400 includes a DC power source 1405, a power feeder module 1410, an LED bulb switch 1415 and a smart LED bulb with built-in module 1430.

Power feeder module 1410 is connected to DC power source 1405 through anode 1408 and cathode 1406. Power feeder module 1410 is also connected to LED bulb switch 1415 and then to Smart LED bulb with built-in module through bulb connector 1450. Power feeder module 1410 includes switching transistors 1412, bias clocking circuit 1414, default voltage reference signal 1416 and timeout circuit 1418. Smart LED bulb with built-in module 1430 include an SCR 1431, voltage differential circuit 1432, switching transistors 1433, bias clocking circuit 1434, operational voltage circuit 1435, diode and filter 1436 and LED 1437.

Power feeder module 1410 operates in the same manner as power feeder module 310, 410, 510, 610 and 1310 previously discussed. Power feeder module 1410 maintains power level demands for LED 1437. SCR 1431, voltage differential circuit 1432, switching transistors 1433 and bias clocking circuit 1434, also function in the same manner as the corresponding circuits described in FIGS. 3-6 previously discussed. Operational voltage circuit 1435 is functionally equivalent to the combination of LVDC measure and memory circuit 1325 and current sensing circuit 1326.

When LED bulb switch 1415 is turned on, a negative signal to SCR 1431 allows LVDC to flow to switching transistors 1433, thereby enabling default voltage reference signal 1416. Further, when LED bulb switch 1415 is turned on a positive signal enables operational voltage circuit 1435.

Operational voltage circuit 1435 signals switching transistors 1433 via bias clocking circuit 1434 to increase voltage output of switching transistors 1433 until a preset voltage is detected by operational voltage circuit 1435 for LED 1437.

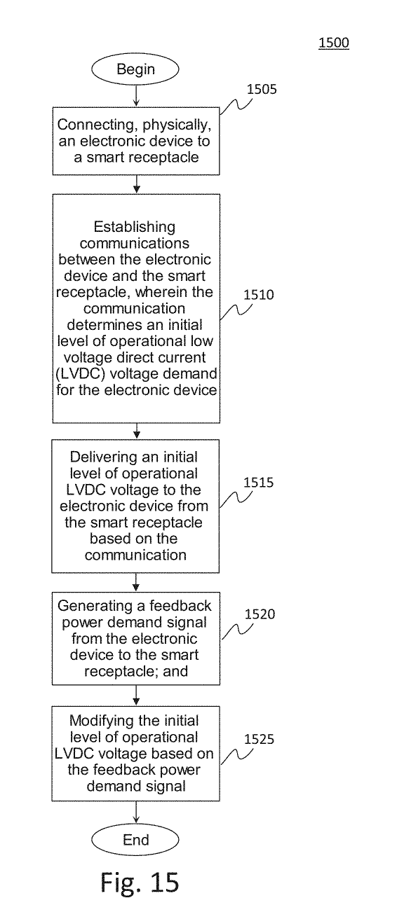

FIG. 15 shows an exemplary embodiment of a method 1500 for low voltage power distribution, according to an embodiment. Method 1500 begins at step 1505 with the coupling of an electronic device to a smart receptacle. For example, FIG. 2 illustrates a smart grid system that includes a power feeder module 210, smart receptacle 220 and electronic power board 230 within an electronic device. As shown in FIG. 3, end-user electronic power board 330 coupled with an electronic device is plugged into smart receptacle 320. In this embodiment the connection uses a three-prong plug consisting of an anode, a cathode and a chassis wire. In another embodiment, as shown in FIG. 4B, a two-prong plug may be utilized that include an anode and a cathode, but no chassis wire.

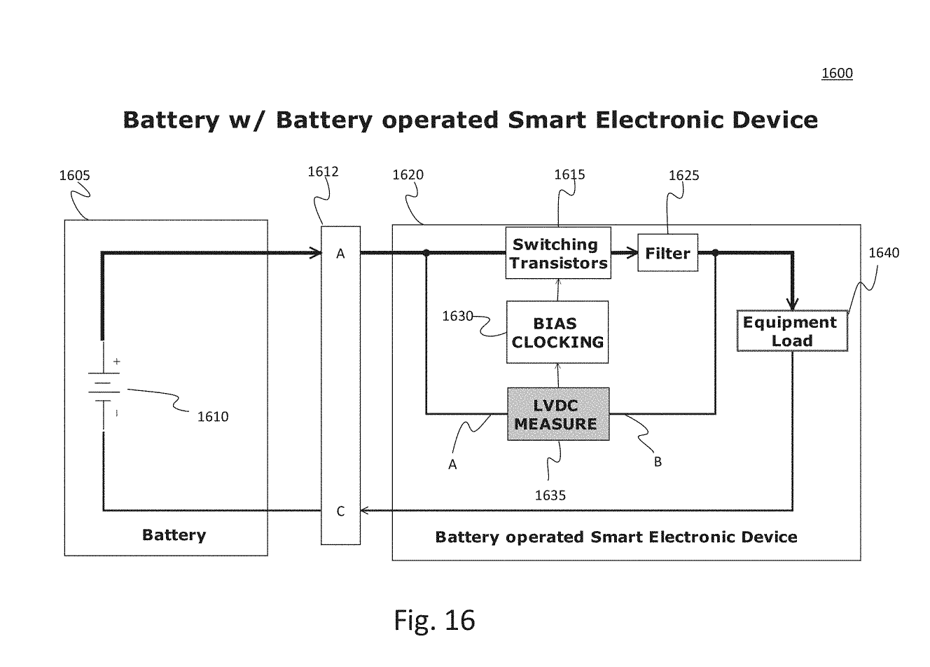

In step 1510, communications are established between the electronic device and the smart receptacle where the communications determine an initial level of operational low voltage direct current voltage demand for the electronic device. For example, as shown in FIG. 5, where the sensor diode is used to feedback a bias signal that is initiated below preset voltage allowing a feedback signal to the feedback limit diode until end-user electronic device operation voltage is achieved. Communications can be defined as an electrical connection as shown in FIG. 5. However, communication can also take the form of digital information transfer as will be shown in FIG. 16.

In step 1515, an initial level of operational LVDC voltage is delivered to the electronic device from the smart receptacle based on the communication. For example, as discussed in FIG. 4B, the bias signal as the communication is present until the LVDC output voltage exceeds its targeted value, e.g., by 20%-30% above the end-user electronic device operational voltage demand. At step 1520, a feedback power demand signal is generated by the electronic device to the smart receptacle. For example, in a three-prong plug embodiment, as discussed in FIG. 3, chassis wire 314 and 324 is used to control bias feedback from end-user electronic power board 330 to smart receptacle 320 and power feeder module 310. In a two-prong embodiment, as discussed in FIG.10, a method of voltage polling is used for feedback control between an electronic device and smart receptacle 420.

At step 1525, the initial level of operational LVDC voltage is modified based on the feedback power demand signal. For example, in a three-prong plug embodiment, as discussed in FIG. 4, where SCR 440 and switching transistors 446 are used to vary LVDC output based on output from bias clocking circuit 448. The method then ends.

FIG. 16 depicts a LVDC smart device 1600, according to an embodiment. LVDC smart device 1600 includes a battery housing 1605 with a battery cell 1610. LVDC smart device 1600 also includes a battery operated smart electronic device 1620 and connector 1612. Battery operated smart electronic device 1620 includes switching transistors 1615, filter 1625, bias clocking circuit 1630, LVDC measure circuit 1635 and equipment load 1640.

Battery housing 1605 with battery cell 1610 provides a constant, while the battery is charged, output voltage at connectors “A” and “C” of connector 1612. When battery operated smart electronic device 1620 is connected to battery housing 1605, or when it is turned on (switch not shown), power from battery cell 1610 flows to switching transistors 1615. Further, LVDC from switching transistors 1615 is conditioned by filter 1625. Such conditioning can include smoothing or any type of conditioning to produce stable LVDC power. The Output of filter 1625 then flows to LVDC measure circuit 1635 to maintain equipment operation voltage.

LVDC measure circuit 1635 signals switching transistors 1615 via bias clocking circuit 1630 to increase voltage output until LVDC measure circuit 1635 no longer senses a current flow to equipment load 1640. Throughout this process, LVDC measure circuit 1635 measures input voltage at pint “a” and records output voltage at point “b” to equipment load 1640. Once the battery operated smart electronic device 1620 is disconnected or turned off, LVDC measure circuit 1635 falls below a predetermined current level and it will no longer compare voltages or generate a feedback signal to bias clocking circuit 1630.

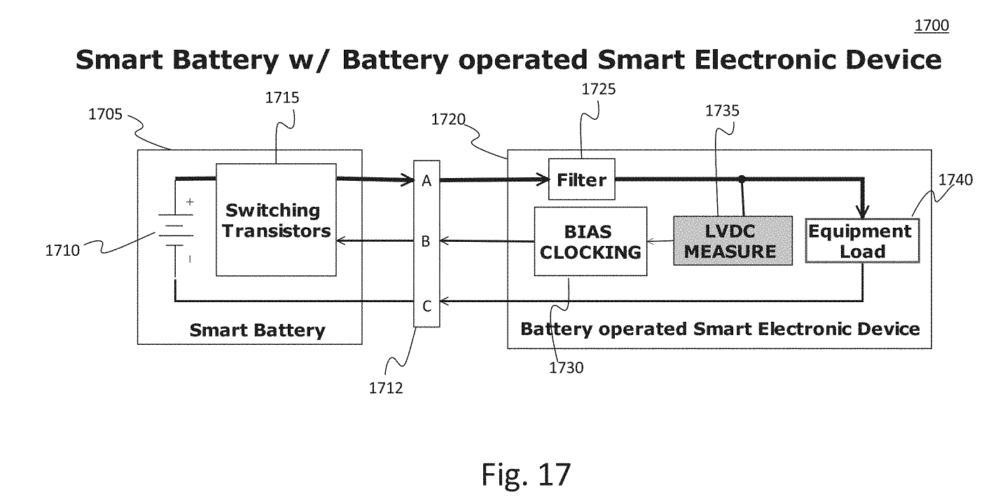

FIG. 17 depicts a LVDC smart device 1700, according to an embodiment. LVDC smart device 1700 includes a smart battery 1705 that includes a battery cell 1710 and switching transistors 1715. LVDC smart device 1700 also includes a battery operated smart electronic device 1720 and connector 1712. Battery operated smart electronic device 1720 includes filter 1725, bias clocking circuit 1730, LVDC measure circuit 1735 and equipment load 1740.

When smart battery 1705 is connected to battery operated smart electronic device 1720 through connector 1712 at contact “A”, “B” and “C”, or when it is turned on (switch not shown), power from battery cell 1710 flows to switching transistors 1715. Further, a positive signal from switching transistors 1715 is conditioned by filter 1725. Such conditioning can include smoothing or any type of conditioning to produce stable LVDC power. The output of filter 1725 then flows to LVDC measure circuit 1735 to maintain equipment operation voltage.

LVDC measure circuit 1735 signals switching transistors 1715 via bias clocking circuit 1730 to increase voltage output until LVDC measure circuit 1735 no longer senses a current flow to equipment load 1740. Throughout this process, LVDC measure circuit 1735 measures and records output voltage to equipment load 1740. Once the battery operated smart electronic device 1720 is disconnected or turned off, LVDC measure circuit 1735 falls below a predetermined current level and it will no longer compare voltages or generate a feedback signal to bias clocking circuit 1730.

### Example Computer System Implementation

Aspects of the present invention shown in FIGS. 1-17, or any part(s) or function(s) thereof, may be implemented using hardware, software modules, firmware, tangible computer readable media having instructions stored thereon, or a combination thereof and may be implemented in one or more computer systems or other processing systems.

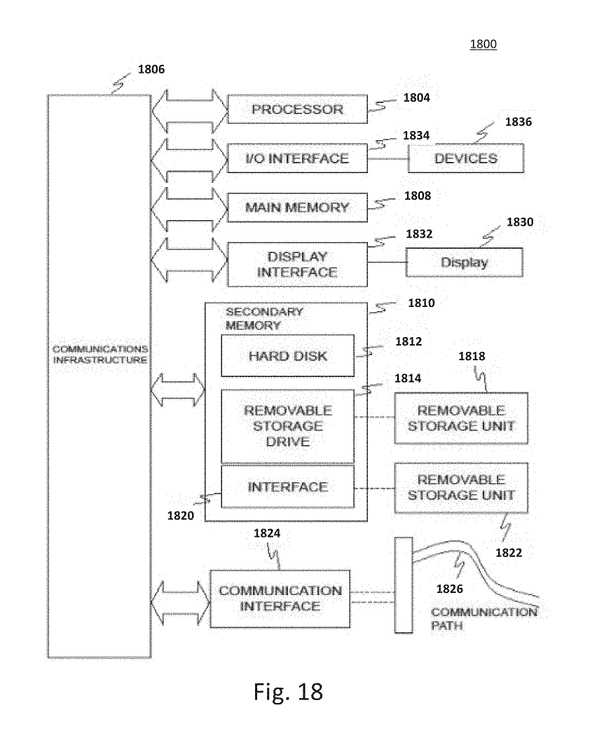

FIG. 18 illustrates an example computer system 1800 in which embodiments, or portions thereof, may be implemented as computer-readable code. For example, portions of the power feeder module, smart receptacle and end-user electronic power board may be implemented in portions of computer system 1800 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-15.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 1800. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1804 may be a special purpose or a general purpose processor device. As will be appreciated by persons skilled in the relevant art, processor device 1804 may also be a single processor in a multi-core/multiprocessor system, such system operating alone, or in a cluster of computing devices operating in a cluster or server farm. Processor device 1804 is connected to a communication infrastructure 1806, for example, a bus, message queue, network, or multi-core message-passing scheme.

Computer system 1800 also includes a main memory 1808, for example, random access memory (RAM), and may also include a secondary memory 1810. Secondary memory 1810 may include, for example, a hard disk drive 1812, removable storage drive 1814. Removable storage drive 1814 may include a floppy disk drive, a magnetic tape drive, an optical disk drive, a flash memory, or the like. The removable storage drive 1814 reads from and/or writes to a removable storage unit 1818 in a well-known manner Removable storage unit 1818 may include a floppy disk, magnetic tape, optical disk, etc. which is read by and written to by removable storage drive 1814. As will be appreciated by persons skilled in the relevant art, removable storage unit 1818 includes a computer usable storage medium having stored therein computer software and/or data.

Computer system 1800 (optionally) includes a display interface 1832 (which can include input and output devices 1836 such as keyboards, mice, etc.) that forwards graphics, text, and other data from communication infrastructure 1806 (or from a frame buffer not shown) for display on display unit 1830. Computer system 1800 is not limited to a particular design and can be a microcontroller, microprocessor, System on integrated circuit (SOIC), application specific integrated circuit, any combination thereof.

In alternative implementations, secondary memory 1810 may include other similar means for allowing computer programs or other instructions to be loaded into computer system 1800. Such means may include, for example, a removable storage unit 1822 and an interface 1820. Examples of such means may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communication interface 1824. Communication interface 1824 allows software and data to be transferred between computer system 1800 and external devices. Communication interface 1824 may include a modem, a network interface (such as an Ethernet card), a communication port, a PCMCIA slot and card, wireless communications including WiFi and cellular, or the like. Software and data transferred via communication interface 1824 may be in the form of signals, which may be electronic, electromagnetic, optical, or other signals capable of being received by communication interface 1824. These signals may be provided to communication interface 1824 via a communication path 1826. Communication path 1826 carries signals and may be implemented using wire or cable, fiber optics, a phone line, a cellular link, a WiFi link, or any other RF link or other communication channels.

In this document, the terms “computer program medium” and “computer usable medium” are used to generally refer to media such as removable storage unit 1818, removable storage unit 1822, and a hard disk installed in hard disk drive 1812. Computer program medium and computer usable medium may also refer to memories, such as main memory 1808 and secondary memory 1810, which may be memory semiconductors (e.g. DRAMs, etc.).

Computer programs (also called computer control logic) are stored in main memory 1808 and/or secondary memory 1810. Computer programs may also be received via communication interface 1824. Such computer programs, when executed, enable computer system 1800 to implement the present invention as discussed herein. In particular, the computer programs, when executed, enable processor device 1804 to implement the processes of the present invention, such as the stages in the method illustrated by flowchart of method 1500 in FIG. 15, as previously discussed. Accordingly, such computer programs represent controllers of the computer system 1800. Where the invention is implemented using software, the software may be stored in a computer program product and loaded into computer system 1800 using removable storage drive 1814, interface 1820, and hard disk drive 1812, or communication interface 1824.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. A method for low voltage power distribution comprising:
coupling an electronic device to a smart receptacle;
establishing a communication between the electronic device and the smart receptacle, wherein the communication determines an initial level of operational low voltage direct current (LVDC) voltage demand for the electronic device;
delivering an initial level of operational LVDC voltage to the electronic device from the smart receptacle based on the communication;
generating a feedback power demand signal from the electronic device to the smart receptacle; and
modifying the initial level of operational LVDC voltage based on the feedback power demand signal.

2. The method of claim 1, wherein the modifying the initial level of operational LVDC voltage is performed by the smart receptacle.

3. The method of claim 2, further comprising modifying the level of operational LVDC voltage through duty cycle modulation in the smart receptacle.

4. The method of claim 1, wherein the initial level of operational LVDC voltage is greater than the operational LVDC voltage demand for the electronic device.

5. The method of claim 4, where in the initial level of operational LVDC voltage is between 20% to 30% greater than the operational LVDC voltage demand for the electronic device.

6. The method of claim 1, further comprising supplying a LVDC voltage to the smart receptacle from a power feeder module.

7. The method of claim 6, wherein the LVDC voltage supplied to the smart receptacle by the power feeder module is preset.

8. The method of claim 6, wherein the LVDC voltage supplied to the smart receptacle by the power feeder module is variable, and wherein the level of LVDC voltage supplied to the smart receptacle is based on a communication between the power feeder module and the smart receptacle.

9. An on-demand system for a low voltage power distribution comprising:
an electronic device comprising an electronic power board; and
a smart receptacle communicatively coupled with the electronic power board,
wherein communication between the smart receptacle and the electronic power board determines an initial level of operational low voltage direct current (LVDC) voltage demand for the electronic device,
wherein the smart receptacle delivers an initial level of operational LVDC voltage to the electronic device based on the communication, and
wherein the electronic power board is further configured to generate a feedback power demand signal to the smart receptacle to modify the initial level of operational LVDC voltage.

10. The on-demand system of claim 9, the smart receptacle further comprising a bias clocking circuit configured to modify the initial level of operational LVDC voltage.

11. The on-demand system of claim 10, the bias clocking circuit further configured to modify the initial level of operations LVDC voltage through duty cycle modulation.

12. The on-demand system of claim 9, wherein the initial level of operational LVDC voltage is greater than the operational LVDC voltage demand for the electronic device.

13. The on-demand system of claim 9, further comprising a plurality of smart receptacles in a smart extension adapter.

14. The on-demand system of claim 9, further comprising a power feeder module configured to supply a preset level of LVDC voltage to the smart receptacle.

15. The on-demand system of claim 9, further comprising a power feeder module including a bias clocking circuit configured to supply a variable level of LVDC voltage to the smart receptacle based on a communication between the power feeder module and the smart receptacle.

16. The on-demand system of claim 9 further comprising a plurality of bridge pins to enable a measurement circuit.

17. A non-transitory computer readable medium with instructions stored thereon to control low voltage direct current (LVDC) distribution, the controlling of the LVDC distribution comprising:
coupling an electronic device to a smart receptacle;
establishing a communication between the electronic device and the smart receptacle, wherein the communication determines an initial level of operational LVDC voltage demand for the electronic device;
delivering an initial level of operational LVDC voltage to the electronic device from the smart receptacle based on the communication;
generating a feedback power demand signal from the electronic device to the smart receptacle; and
modifying the initial level of operational LVDC voltage based on the feedback power demand signal.

18. The non-transitory computer readable medium of claim 17, further comprising supplying a LVDC voltage to the smart receptacle from a power feeder module wherein the LVDC voltage supplied to the smart receptacle by the power feeder module is variable, and wherein the level of LVDC voltage supplied to the smart receptacle is based on a communication between the power feeder module and the smart receptacle.

19. The non-transitory computer readable medium of claim 17, wherein the modifying the initial level of operational LVDC voltage is performed by the smart receptacle.

20. The non-transitory computer readable medium of claim 17, wherein the initial level of operational LVDC voltage is between 20% to 30% greater than the operational LVDC voltage demand for the electronic device.

21. An on-demand system for a low voltage lighting system comprising:
a smart LED module and a power board comprising a LED light source;
a power feeder module configured to supply a low voltage direct current (LVDC) to the smart LED module; and
a switch configured to control power flow from the power feeder module to the smart LED module,
wherein when the switch is engaged to allow power flow from the power feeder module to the smart LED module, a voltage level of the LVDC supplied by the power feeder module is based on a feedback signal from the smart LED module,
wherein communication between the smart LED module and the power board determines an initial level of operational LVDC voltage demand for the LED light source,
wherein the smart LED module delivers an initial level of operational LVDC voltage to the LED light source based on the communication, and
wherein the power board is further configured to generate a feedback power demand signal to the smart LED module to modify the initial level of operational LVDC voltage.

22. The on-demand system of claim 21, the smart LED module further comprising a bias clocking circuit configured to modify the initial level of operational LVDC voltage.

23. The on-demand system of claim 22, the bias clocking circuit further configured to modify the initial level of operations LVDC voltage through duty cycle modulation.

24. The on-demand system of claim 21, wherein the initial level of operational LVDC voltage is greater than the operational LVDC voltage demand for the LED light source.

25. The on-demand system of claim 21, further wherein the power feeder module is further configured to supply a preset level of LVDC voltage to the smart LED module.

26. The on-demand system of claim 21, wherein the power feeder module is further configured to include a bias clocking circuit configured to supply a variable level of LVDC voltage to the smart LED module based on a communication between the power feeder module and the smart LED module.
